(19) United States
(12) Patent Application Publication
(10) Pub. No.: US 2005/0015400 A1
(43) Pub. Date: Jan. 20, 2005

(54) Existing content utilization support method, information processing device, program, and recording medium

(75) Inventors: Toyomitsu Yoneda, Kawasaki (JP); Shuji Soga, Kawasaki (JP); Nobuki Tsuchida, Kawasaki (JP); Masato Tamaki, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/818,726

(22) Filed: Apr. 5, 2004

(30) Foreign Application Priority Data
Jul. 17, 2003 (JP) 2003-198426

(51) Int. Cl. G06F 7/00

(52) U.S. Cl. 707/102

(57) ABSTRACT

An existing content utilization support method including the steps of accepting information on a requirement in which contents scheduled to be designed have different design contents from those of existing contents from an input interface, checking the requirement information against a first database to retrieve the corresponding physical design purpose or the corresponding physical design target, checking the retrieved physical design purpose or the retrieved physical design target against a second database to extract the corresponding customization process, and outputting information on the extracted customization process to an output interface.

### CROSS-REFERENCE TO RELATED APPLICATIONS

The present application claims priority upon Japanese Patent Application No. 2003-198426 filed on Jul. 17, 2003, which is herein incorporated by reference.

### BACKGROUND OF THE INVENTION

1. Field of the Invention

The present invention relates to an existing content utilization support method, an information processing device, a program, and a recording medium.

2. Description of the Related Art

Heretofore, methods for customizing and reutilizing contents designed on the premise that the contents will be reutilized have been provided.

For example, in order to accomplish the object of realizing a business system construction device and a business system capable of reducing the development cost of a business system by creating flexible software which has high reusability and which is easy to customize, the following business system construction device and the like have been proposed. (Refer to Japanese Patent Application Laid-open Publication No. 2002-358200). Specifically, the business system construction device includes software creation means and construction means. The software creation means creates middleware which is infrastructure software commonly used among industries, an industry-classified framework constituting a skeleton part of software created for each industry, and a component which is a standard or custom variation module prepared in accordance with a request of a customer and which is appropriately attached/detached to/from the industry-classified framework. The construction means constructs business system software by combining the middleware, the industry-classified framework, and the component.

However, a method for customizing and reutilizing contents designed without the assumption that the contents will be reutilized has not been provided. Accordingly, the present invention was achieved based on the above-described background and provides an existing content utilization support method, an information processing device, a program, and a recording medium which enable existing contents to be reutilized without premising design in which reutilization is assumed.

### SUMMARY OF THE INVENTION

Features and objects of the present invention other than the above will become clear by reading the description of the present specification with reference to the accompanying drawings.

An existing content utilization support method of the present invention which achieves the above-described object is a method in which existing content utilization support is performed by an information processing device. The information processing device can access a first database in which physical design purposes and physical design targets of the existing contents are described and a second database in which a list of customization processes performable on the respective physical design purposes and the respective physical design targets in the first database is described. The method includes the steps of accepting information on a requirement in which contents scheduled to be designed have different design contents from those of the existing contents from an input interface, checking the requirement information against the first database to retrieve any of the corresponding physical design purpose and the corresponding physical design target, checking any of the retrieved physical design purpose and the retrieved physical design target against the second database to extract the corresponding customization process, and outputting information on the extracted customization process to an output interface.

Moreover, the present invention relates to an information processing device for supporting utilization of existing contents The information processing device includes a first database in which physical design purposes and physical design targets of the existing contents are described, a second database in which a list of customization processes performable on the respective physical design purposes and the respective physical design targets in the first database is described, an input interface for accepting information on a requirement in which contents scheduled to be designed have different design contents from those of the existing contents, a unit for checking the requirement information against the first database and for retrieving any of the corresponding physical design purpose and the corresponding physical design target, a unit for checking any of the retrieved physical design purpose and the retrieved physical design target against the second database and extracting the corresponding customization process, and a unit for outputting information on the extracted customization process to an output interface.

Furthermore, the present invention relates to a program for making an information processing device to support utilization of existing contents, which is for making the information processing device being capable of accessing a first database, in which physical design purposes and physical design targets of the existing contents are described, and a second database, in which a list of customization processes performable on the respective physical design purposes and the respective physical design targets in the first database is described, to achieve support for utilization of the existing contents. The program comprises the steps of: accepting information on a requirement in which contents to be designed have different design contents from those of the existing contents, from an input interface; checking the requirement information against the first database to retrieve any one of the corresponding physical design purpose and the corresponding physical design target; checking any one of the retrieved physical design purpose and the retrieved physical design target against the second database to extract the corresponding customization process; and outputting information on the extracted customization process to an output interface This program includes codes for performing the operations of the above-described steps.

In addition, the present invention relates to a computer-readable recording medium having the above-described existing content utilization support program recorded thereon

Features and objects of the present invention other than the above will become clear by reading the description of the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is a system configuration diagram including an existing content utilization support system (information processing device) in an embodiment of the present invention;

FIG. 2 is a view showing an example of a data structure of a workshop group (first database);

FIG. 3 is a view showing Database Group 1 in the embodiment;

FIG. 4 is a view showing Database Group 2 in the embodiment;

FIG. 5 is a view showing a workshop-classified customization work matrix in the embodiment;

FIG. 6 is a view showing Database Group 3 in the embodiment;

FIG. 7 is a view showing Database Group 4 in the embodiment;

FIG. 8 is a diagram showing the main flow of an existing content utilization support method of the embodiment;

FIG. 9 is a diagram showing a flow for creating requirement GAPs for each workshop;

FIG. 10 is a diagram showing a flow for selecting customization works for each workshop;

FIG. 11 is a diagram showing a flow for creating a customization work combination plan definition table;

FIG. 12 is a diagram showing a flow for accumulating and displaying customization risk points for each customization work combination plan;

FIG. 13 is a diagram showing a flow for checking whether there are five or more types of units;

FIG. 14 is a diagram showing a flow to check that different customization works are used for the same purpose; and

FIG. 15 is a view showing a work table group.

### DETAILED DESCRIPTION OF THE INVENTION

At least the following matters will be made clear by the explanation in the present specification and the description of the accompanying drawings.

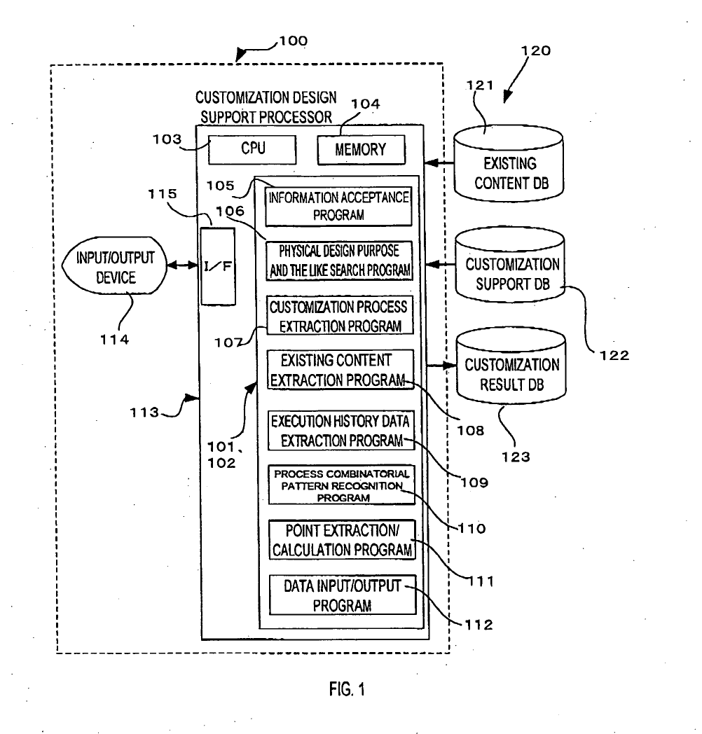

Hereinafter, an embodiment of the present invention will be described in detail using the accompanying drawings. FIG. 1 is a system configuration diagram including an existing content utilization support system (information-processing device) in the present embodiment. The existing content utilization support system 100 (hereinafter, “system”) as an information processing device in the present invention has a program group 101 for realizing the existing content utilization support method of the present invention on a storage device 102 such as a hard disk drive or a nonvolatile memory.

A CPU 103, which is an arithmetic unit of the system 100, loads appropriate programs 105 to 112 into a memory 104 by reading out the programs from the program group 101 on the storage device 102 and executes the programs in accordance with operating systems (OSs), thereby realizing the existing content utilization support method. The program group 101 includes a requirement information acceptance program 105, a physical design purpose and the like search program 106, a customization process extraction program 107, an existing content extraction program 108, an execution history data extraction program 109, a process combinatorial pattern recognition program 110, a point extraction/calculation program 111, and a data input/output program 112.

It is assumed that a customization design support processor 113 has functions realized by the program group 101. Moreover, of course, the system 100 as an information processing device is equipped with an interface 115 for transmitting/receiving data to/from various kinds of external devices and an input/output device 114, which includes an output interface for outputting various kinds of data and an input interface for accepting selections and directions from an operator of the concerned system.

The system 100 described above has a database group 120 (or can access the database group 120 through a network). The database group 120 includes an existing content database 121, which is a third database where design contents for each existing content are described, a customization support database 122, and a customization result database 123. Next, details of these databases 121, 122, and 123 will be described.

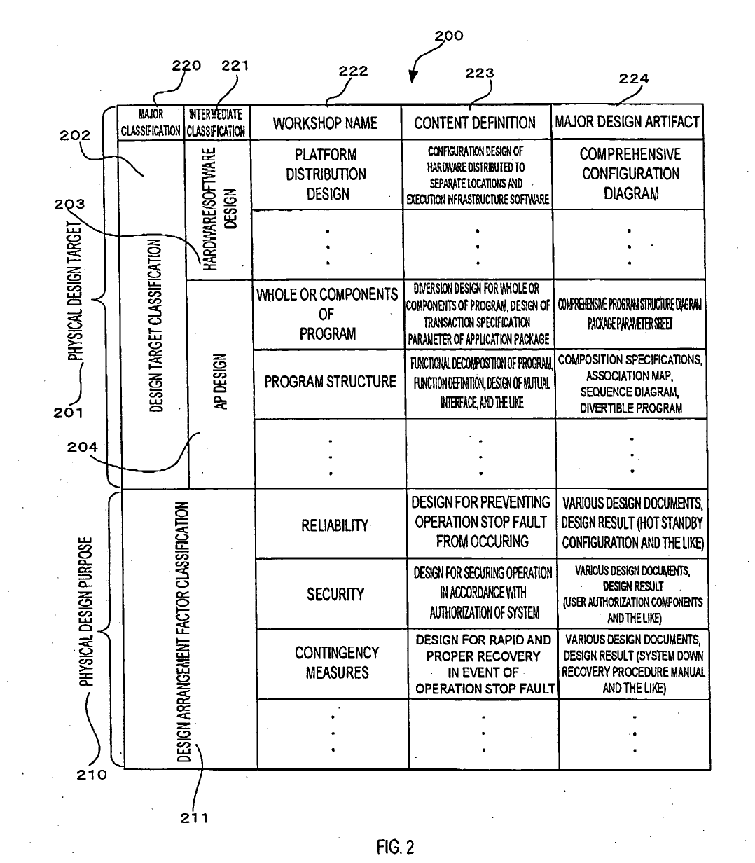

FIG. 2 is a view showing an example on a data structure of a workshop group (first database). In the existing content utilization support method of the present embodiment, a concept of a workshop is employed. The workshop group 200, which is a collection of workshops, corresponds to a first database in the present invention. The workshop group 200 can be contained in any of the databases constituting the database group 120. Alternatively, the customization design support processor 113 may have the workshop group 200.

The data structure of the workshop group 200 is a structure in which information on workshop 222 is described by sorting physical design targets 201 and physical design purposes 210 of contents according to a major classification 220 and an intermediate classification 221. The data structure described above can be regarded as a framework. In the physical design target 201, which is a functional requirement including hardware specifications, software specifications, and application specifications of the existing contents, information on content definitions 223 and major design artifacts 224 of the workshops 222 classified into hardware/software design 203 of design targets 202 is described.

Moreover, in the classification of application design 204, information on content definitions 223 and major design artifacts 224 of workshops 222 are also described similarly. On the other hand, in the physical design purposes 210, which are non-functional requirements unrelated to the application specifications of the existing contents, information on the content definition 223 and major design artifact 224 of each workshop 222 is described in accordance with classification depending on design arrangement factors 211.

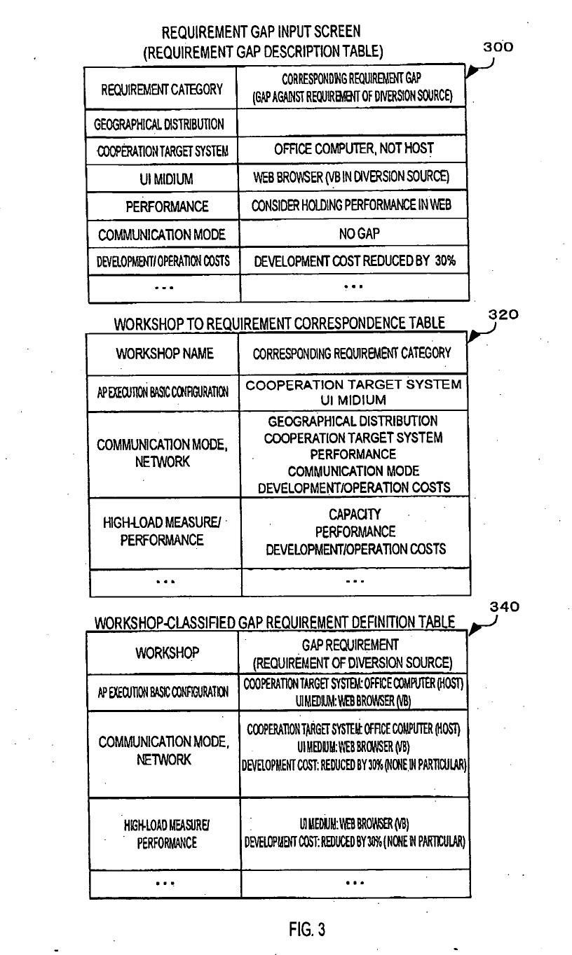

FIG. 3 is a view showing Database Group 1 in the present embodiment. A requirement GAP description table (input screen) 300, a workshop to requirement correspondence table 320, and a Workshop-classified GAP requirement definition table 340 are included in Database Group 1.

The requirement GAP description table (input screen) 300 and the workshop to requirement correspondence table 320 are stored, for example, in the customization support database 122. The requirement GAP description table (input screen) 300 is displayed through the input/output device 114 to a person performing content design A requirement GAP which accepts an input is accepted here means a gap between a design requirement of the existing content to be reutilized and that of the content to be designed. Moreover, the input of a requirement GAP is accepted for each requirement category set in the requirement GAP description table 300.

On the other hand, the workshop-classified GAP requirement definition table 340 is stored, for example, in the customization result database 123. The definition table 340 has a data structure where the requirement GAPs whose input has been accepted on the requirement GAP input screen 300 are organized depending on the corresponding workshops 222 using the workshop to requirement correspondence table 320.

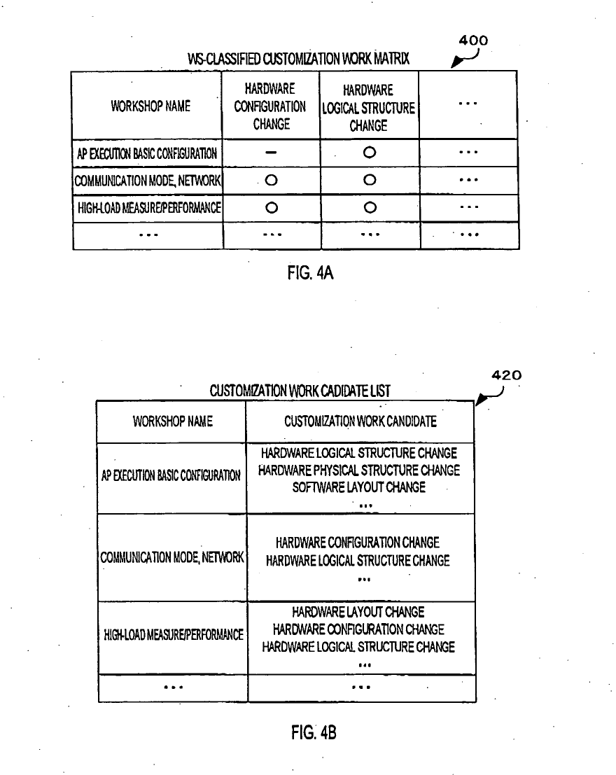

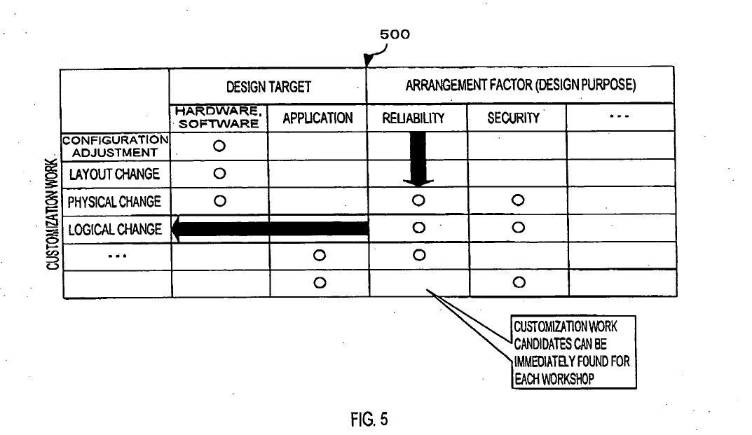

FIG. 4 is a view showing Database Group 2 in the present embodiment. A workshop (WS)-classified customization work matrix 400 and a customization work candidate list 420 are included in Database Group 2. The workshop (WS)-classified customization work matrix 400 is a matrix in which practicable customization works are defined for each workshop 222 such as the physical design targets and the physical design purposes. FIG. 5 is a view showing details of the matrix. Note that the matrices 400 and 500 shown in FIGS. 4 and 5 mean a second database of the present invention and are contained in the customization support database 122.

Moreover, customization refers to a process of modifying a design content of the existing content to fill a gap between the existing content and the content to be designed. In the customization work candidate list 420, practicable customization work candidates are listed for each workshop 222 by checking the workshop-classified GAP requirement definition table 340 and the workshop (WS)-classified customization work matrix 400.

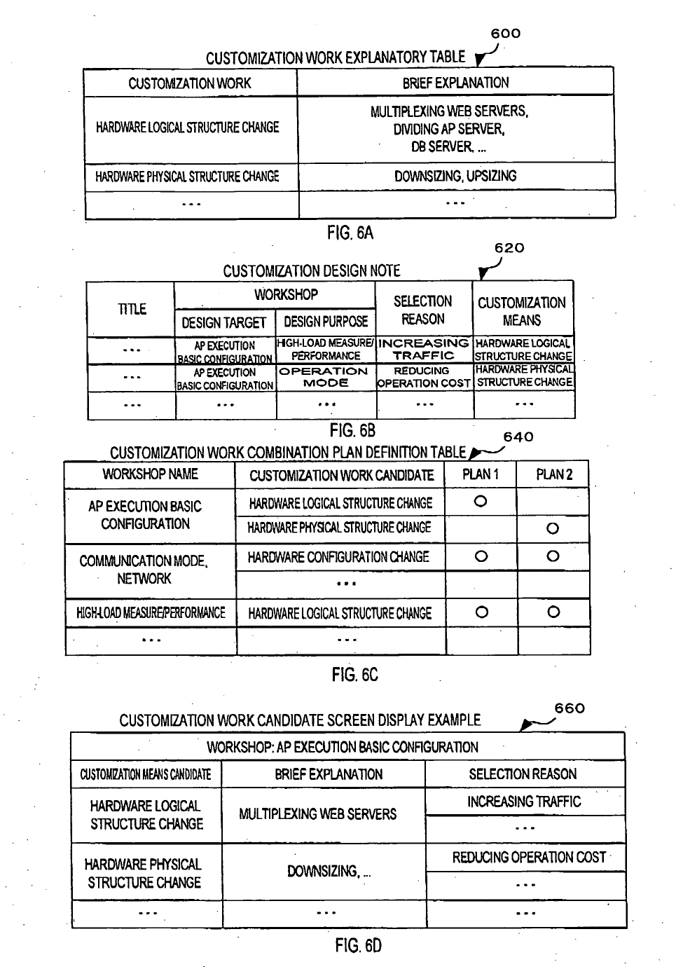

FIG. 6 is a view showing Database Group 3 in the present embodiment. A customization work explanatory table 600, a customization design note 620, a customization work combination plan definition table 640, and a customization work candidate screen display example 660 are included in this database group.

The customization work explanatory table 600 is contained in the customization support database 122 and is a table in which work contents are described for each customization work. The customization design note 620 is contained in the existing content database 121 and can be said to be a fourth database which stores execution history data of customization processes. In the customization design note 620, a selected customization unit and a reason for the selection thereof are contained as data for each workshop 222.

The customization work combination plan definition table 640 is contained in the customization result database 123. The customization work combination plan definition table 640 accepts selections for the customization work candidates for each workshop 222 which have been shown in the customization work candidate screen display example 660. In the present embodiment, customization work candidates are listed for each workshop 222. Among the customization work candidates, ones for which selections have been accepted are associated with, for example, a circle.

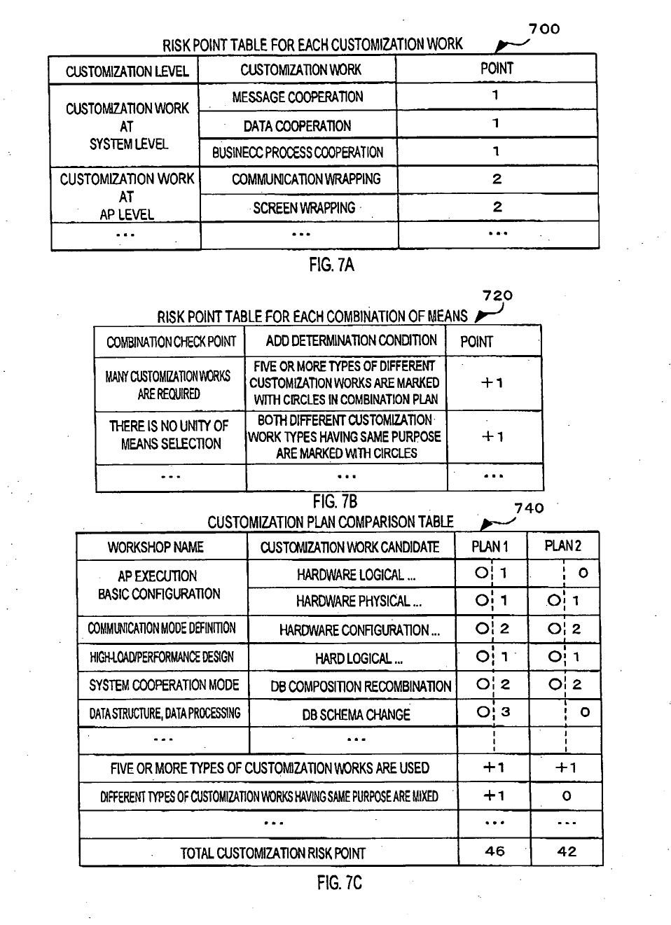

FIG. 7 is a view showing Database Group 4 in the present embodiment. A risk point table for each customization work 700, a risk point table for each combination of units 720, and a customization plan comparison table 740 are contained in this Database Group 4. The risk point table for each customization work 700 is contained in the customization support database 122. Moreover, the risk point table for each customization work 700 can be regarded as a fifth database in which relationships between customization works and points of process risk level set for the respective customization works are defined.

Further, the risk point table for each combination of units 720 is contained in the customization support database 122. Moreover, the risk point table for each combination of units 720 can be regarded as a sixth database in which risk points (combination-considered points) of a process risk level are defined. The risk points of process risk level are corresponding to at least any one of the total number of customization processes included in each combinatorial pattern of customization units, the number of different customization processes corresponding to the same requirement information, and the degree of complexity of a customization process.

The customization plan comparison table 740 is a result of executing the existing content utilization support method of the present invention and stored in the customization result database 123. To cite an example of a data structure, selectable customization work candidates are listed for each workshop 222, and patterns in which customization works are selected from the list are shown as plans. Moreover, each plan is associated with a total risk point obtained by calculating risk points of each customization work and risk points of each combination of units.

Incidentally, the existing content database 121, the customization support database 122, and the customization result database 123 constituting the database group 120 may be attached to another device to operate integrally with the system 100 through a network, other than the example of being integrally incorporated in the system 100.

Moreover, for the respective networks for coupling between the system 100, the database group 120, and external devices, various networks including a private line, a wide area network (WAN), Powerline Internet, a wireless network, a public phone network, a cellular phone network, and an electronic data interchange (EDI) private network can be employed, other than a LAN and the Internet. Further, the use of virtual private network technology, such as VPN, establishes communications with increased security when the Internet is employed, thus being suitable.

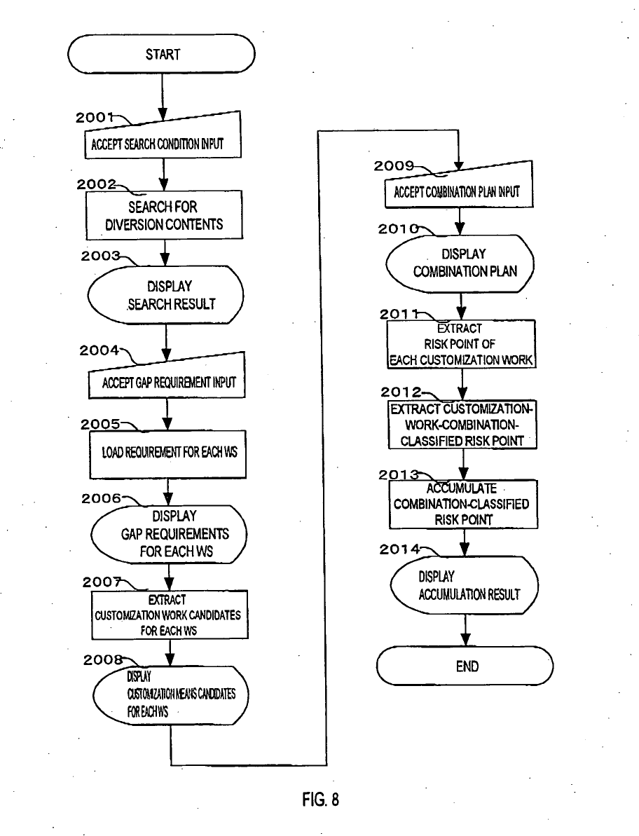

FIG. 8 is a diagram showing the main flow of the existing content utilization support method of the present invention. Hereinafter, actual procedures of the existing content utilization support method of the present invention will be described. Incidentally, various kinds of operations corresponding to the existing content utilization support method described below are realized by the programs 105 to 112 installed in the system 100. Further, these programs include codes for performing various kinds of operations described below. Moreover, the information acceptance program 105 performs a function of accepting various kinds of information from a user or the like through the input/output device 114 commonly in the respective procedures, and the data input/output program 112 performs a function of inputting/outputting data, commonly in the respective procedures.

The system 100 accepts requirement information, in which the contents scheduled to be designed have different design contents from those of the existing contents, from the input/output device 114. In order to do this, first, the input of information on design contents required by the contents scheduled to be designed is accepted as a search condition (2001). Then, the existing content extraction program 108 is executed, and the accepted design content information is checked against the existing content database 121, thus extracting appropriate existing contents (2002).

The list of the extracted existing contents is outputted to the input/output device 114 (2003). Then, differences between design contents of the outputted existing contents and those of the contents scheduled to be designed are accepted as the GAP requirement (requirement information) (2004). The input acceptance screen thereof is the screen 300 shown in FIG. 3.

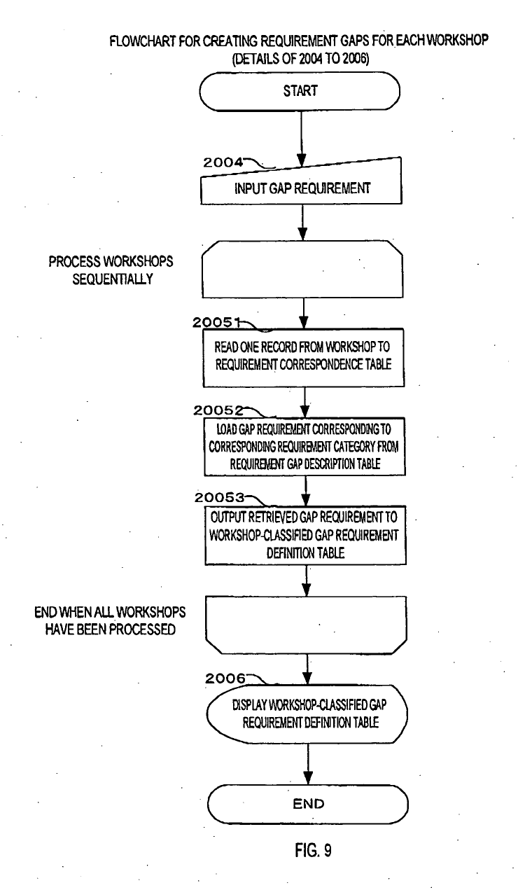

Based on the GAP requirement accepted here, the Workshop-classified GAP requirement definition table 340 is generated. The flow thereof is shown in FIG. 9. The system 100 executes the physical design purpose and the like search program 106 to read one record, i.e., a record relating to one workshop, from the workshop to requirement correspondence table 320 (20051).

Then, a GAP requirement falling under the corresponding requirement category is loaded from the requirement GAP description table 300 (20052). The retrieved GAP requirement is outputted to the Workshop-classified GAP requirement definition table 340 (20053). This process is performed on all records constituting the workshop to requirement correspondence table 320, i.e., all workshops. When the relevant process is finished, the Workshop-classified GAP requirement definition table 340 is completed to be outputted (2006).

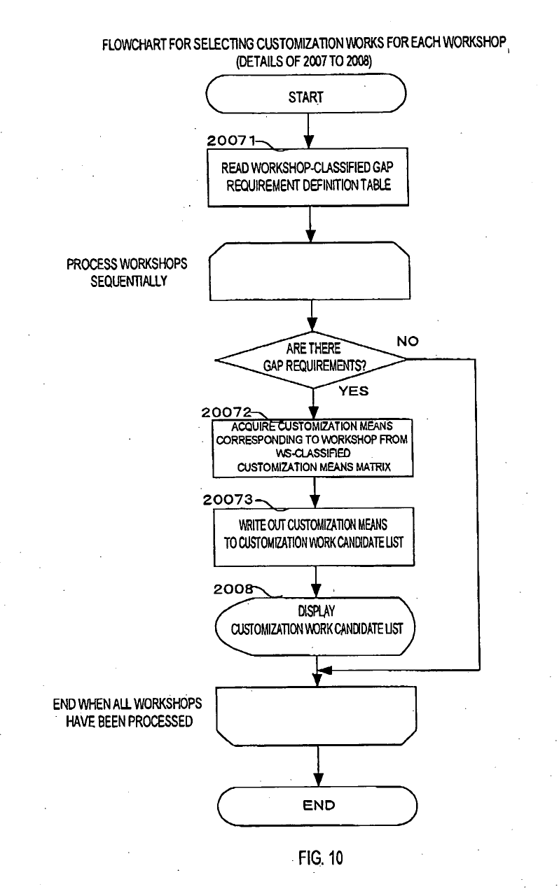

Subsequently, the system 100 executes the customization process extraction program 107 to extract customization work candidates for each workshop (2007). FIG. 10 is a diagram showing a flow for selecting customization works for each workshop. The system 100 reads the Workshop-classified GAP requirement definition table 340 (20071). Then, whether there are GAP requirements or not is determined for each contained workshop. If there are no requirements, the process is terminated. On the other hand, if there are requirements, a customization unit corresponding to the workshop is acquired from the workshop-classified customization unit matrix 400 and 500 (20072). The acquired customization unit is written out to the customization work candidate list 420, and this is displayed (20073, 2008). This work is performed on all workshops.

Next, the system 100 executes the process combinatorial pattern recognition program 110. If the number of the written out customization works for one workshop (physical design purpose or physical design target) is more than one, the designation of a combinatorial pattern of these customization works is accepted (2009). Alternatively, the system 100 itself recognizes all combinations.

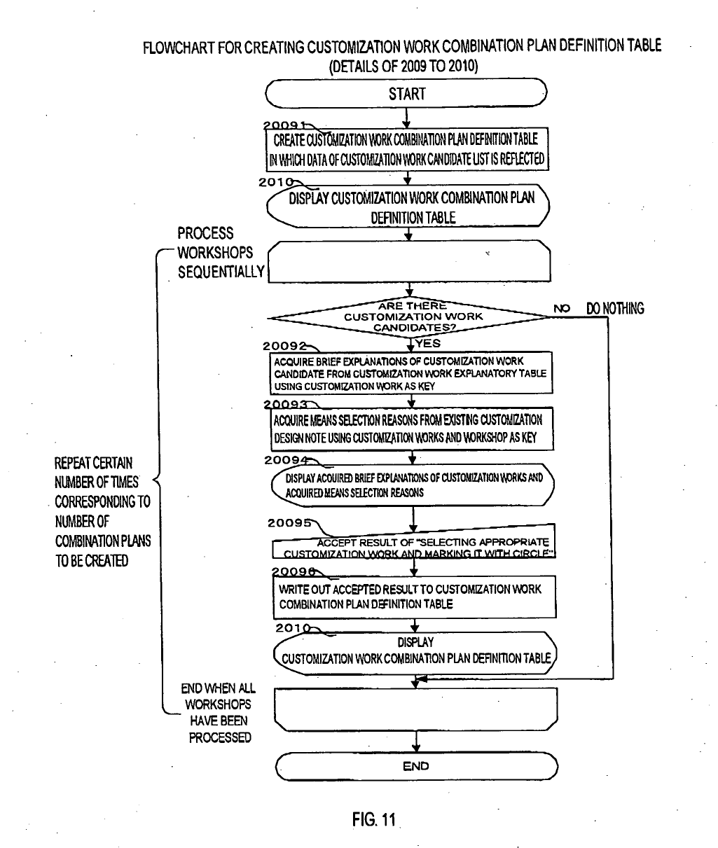

FIG. 11 is a diagram showing a flow for creating a customization work combination plan definition table. At this time, the system 100 creates the customization work combination plan definition table 640 in which data of the customization work candidate list 420 is reflected (20091). Then, the customization work combination plan definition table 640 is displayed (2010). Whether there is a customization work candidate or not is determined for each workshop in this definition table 640. If there are no customization work candidates, the process is terminated. On the other hand, if there are customization work candidates, the brief explanations of the relevant customization work candidates are acquired from the customization work explanatory table 600 using the customization works as keys (20092).

Moreover, the execution history data extraction program 109 is executed, thus acquiring the relevant unit selection reasons from the customization design note 620 using the customization works and the workshops as keys (20093). The acquired brief explanations of the customization works and the acquired unit selection reasons are displayed on the input/output device 102 (2094). The selection of a specific customization work among the customization work candidates is accepted through the input/output device 114. Alternatively, the system 100 selects a specific customization work in accordance with a previously defined algorithm (20095).

For the selected customization work, the relevant area in the definition table 640 is marked with, for example, a circle (20095, 20096). The marked definition table 640 is outputted (2010). Such a process is performed on all workshops, and then the process is finished.

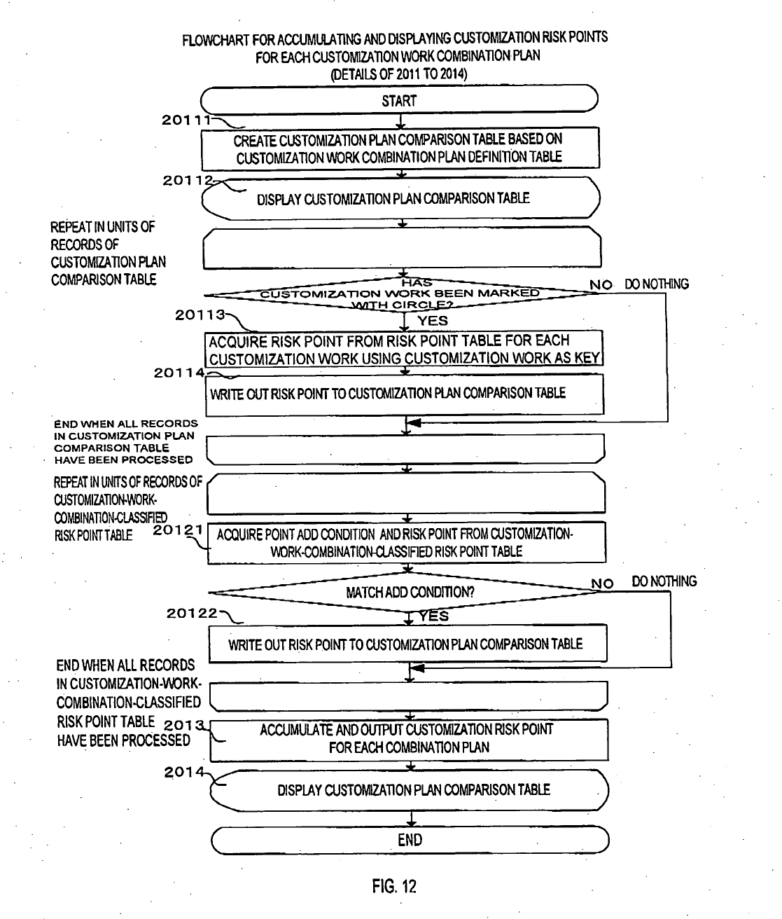

After customization work selection is performed for each workshop, the system 100 which has recognized the combinatorial patterns thereof executes the point extraction/calculation program 111, and then calculates risk points of the customization works (2011). FIG. 12 is a diagram showing a flow for accumulating and displaying customization risk points for each customization work combination plan.

The system 100 creates the customization plan comparison table 740 based on the customization work combination plan definition table 640 (20111) and displays the customization plan comparison table 740 (20112). Then, whether there is a mark or not is determined for one record in this comparison table 740, i.e., for each customization work. If there is no mark, the process is once terminated, and another process is carried out. On the other hand, if there is a mark, the relevant risk point is acquired from the risk point table for each customization work 700 using the customization work as a key (20113) and written out to the customization plan comparison table 740 (20114). This process is performed on all customization works.

Subsequently, each plan in the customization plan comparison table 740, i.e., each combinatorial pattern, is checked against the risk point table for each combination of units 720, thus determining whether the combinatorial pattern matches point addition conditions or not (20121). If the combinatorial pattern does not match a point addition condition, a point is not added. On the other hand, if the combinatorial pattern matches a point add condition, the relevant risk point is acquired and written out to the comparison table 740 (20122). When this process is finished for all combinatorial patterns, the total risk point (customization risk point) for each combinatorial pattern is accumulated and displayed on the comparison table 740 (2013, 2014).

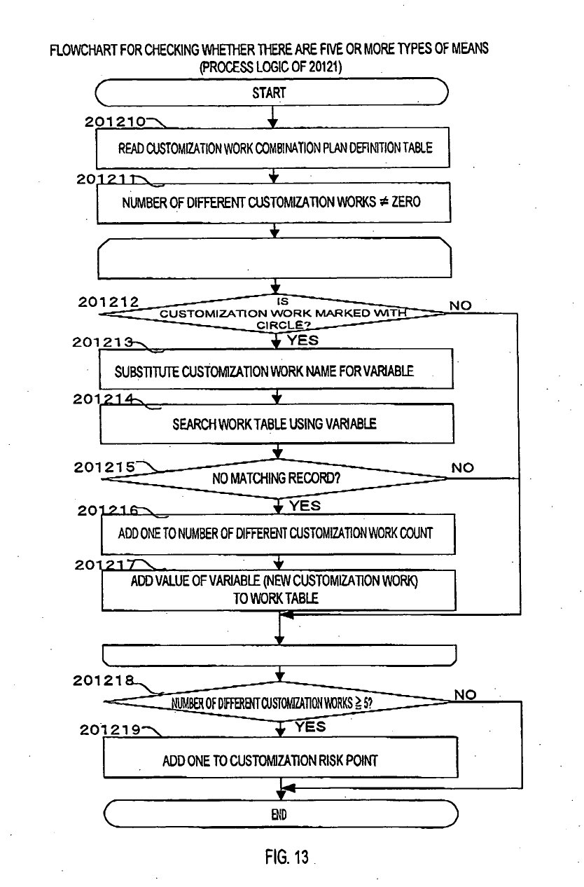

A detailed flow for calculating a risk point for each unit combination is described below depending on cases. FIG. 13 is a diagram showing a flow for checking whether there are five or more types of units or not. The system 100 performs a check on a condition that “five or more types of different customization works are marked with circles in a combination plan” among the add determination conditions in the risk point table for each combination of units 720. At this time, the customization work combination plan definition table 640 is read (201210).

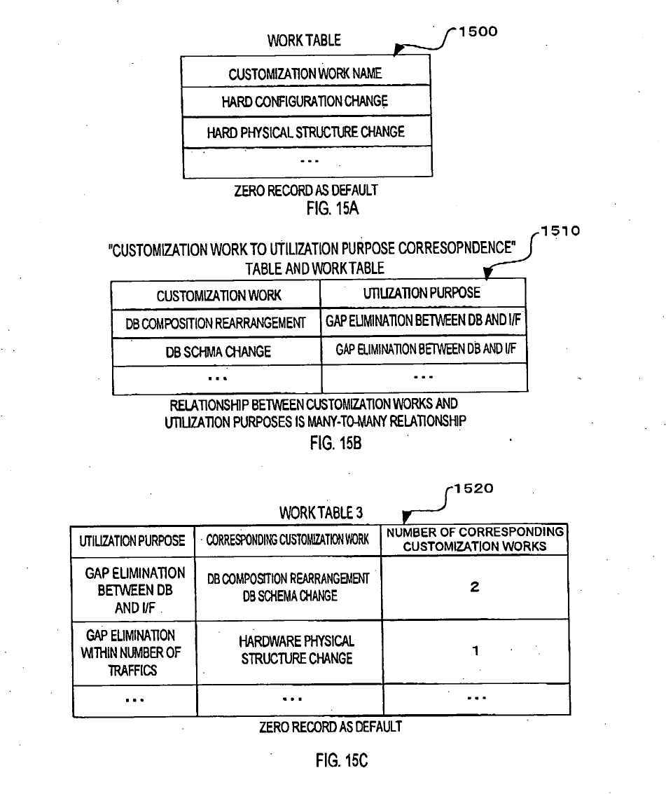

Then, the fact that the number of different customization works is not zero is confirmed (201211), and whether the customization work has been marked or not is determined (201212). If the customization work has not been marked, the process is terminated. On the other hand, if the customization work has been marked, the customization work name is substituted for a variable (201213). This variable becomes a search condition in a work table 1500 (FIG. 15) in which customization work names are stored (201214). In the work table 1500, whether there is a matching record or not is determined (201215). If there is no matching record, the customization work name is added as a new customization work name to the work table 1500 (201217). At this time, since the number of different customization works has increased, the count is added (201216).

This work is performed on all customization works relating to the same workshop, and whether the number of customization works counted becomes ultimately five or more or not is determined (201218). If the number is determined to be five or more, an addition condition of a risk point of each combination of units is satisfied. Therefore, one is added to the customization risk point in the customization plan comparison table 740.

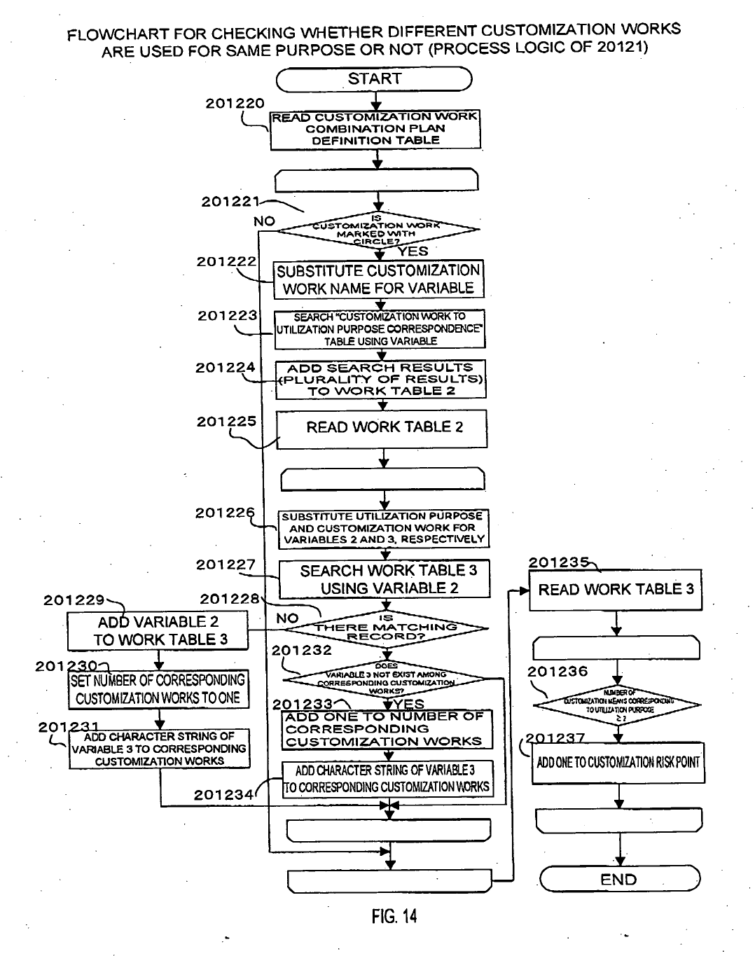

Moreover, it is also possible to determine whether different types of customization works having the same purpose have been marked in one workshop or not. FIG. 14 is a diagram showing a flow for checking whether different customization works are used for the same purpose or not. The system 100 reads the customization work combination plan definition table 640 (201220). Then, whether each customization work has been marked or not is determined (201221). If the customization work has been marked, the customization work name is substituted for a variable (201222). This variable becomes a search condition in a customization work to utilization purpose correspondence table 1510 (FIG. 15) (201223). The search result is added to the work table 1510, and the work table 1510 is read (201224, 201225).

Subsequently, the utilization purpose in the work table 1510 is substituted for variable 2, and the customization work is substituted for variable 3 (201226). The work table 1520 is searched using variable 2 (201227), and whether there is a matching record or not is determined (201228). If there is no matching record, variable 2 is added to the work table 1520 (201229), and the number of corresponding customization works is set to one (201230). Moreover, the character string of variable 3 is added to the number of corresponding customization works (201231).

On the other hand, if it has been determined that there is a matching record in the determination (201228), whether variable 3 exists among the corresponding customization works or not is determined (201232). Here, if Variable 3 exists, one is added to the number of corresponding customization works (201233), and the character string of variable 3 is added to the number of corresponding customization works (201234).

The system 100 reads the work table 1520 (201235) and determines whether the number of customization units corresponding to each utilization purpose is two or more (201236). If the number has been determined to be two or more, one is added to the customization risk point in the customization plan comparison table 740 (201237).

According to the customization plan comparison table 740 created in this way, for example, a designer or the like of a content focuses on a combinatorial pattern in which the total risk point is lower, thus easing the selection of a combination of customization works for each workshop.

The existing content utilization support method and the like of the present invention enable existing contents to be reutilized without premising design in which reutilization is assumed.

According to the present invention, it is possible to reutilize existing contents without premising design in which reutilization is assumed.

Although the preferred embodiment of the present invention has been described in detail, it should be understood that various changes, substitutions and alterations can be made therein without departing from spirit and scope of the inventions as defined by the appended claims.

1. A method for supporting utilization of existing contents comprising the steps of:
storing physical design purposes and physical design targets of the existing contents in a first database;
storing a list of customization processes performable on any of the respective physical design purposes and the respective physical design targets in the first database, into a second database;
accepting, from an input interface, information on a requirement in which contents scheduled to be designed have different design contents from those of the existing contents;
checking said requirement information against said first database and retrieve any of the corresponding physical design purpose and the corresponding physical design target;
checking any of said retrieved physical design purpose and said retrieved physical design target against said second database to extract the corresponding customization process; and
outputting information on said extracted customization process to an output interface.

2. A method according to claim 1, further comprising the steps of:
storing the design contents of each existing content in a third database;
accepting information on the design contents required for the contents scheduled to be designed from the input interface;
checking said accepted design content information against said third database to extract the relevant existing content;
outputting a list of said extracted existing content to the output interface; and
accepting a difference of design contents with said outputted existing content as said requirement information.

3. A method according to claim 1,
wherein the physical design purposes of the contents in said first database comprise non-functional requirements unrelated to application specifications of the existing contents, and said physical design targets comprise functional requirements including any of hardware specifications, software specifications, and the application specifications of the existing contents, and
in the step of accepting said requirement information, any of said non-functional requirements and said functional requirements is accepted as the requirement information.

4. A method according to claim 1, further comprising the steps of:
storing execution history data of said customization process in a fourth database;
checking said extracted customization process against said fourth database to extract the execution history data on the relevant customization process; and
outputting said extracted execution history data to the output interface.

5. A method according to claim 1, further comprising the steps of:
recognizing combinatorial patterns of said customization processes if the number of the extracted customization processes for any of one physical design purpose and one physical design target is more than one; and
outputting said recognized combinatorial patterns to the output interface.

6. A method according to claim 5, further comprising the steps of:
storing relationships between said customization processes and points of process risk level set for the respective customization processes in a fifth database;
checking said extracted customization processes against said fifth database to extract the points according to process risk level of the customization processes; and
accumulating said points for each said combinatorial pattern to output the accumulated points to the output interface.

7. A method according to claim 6, further comprising the steps of:
storing a combination-considered point of process risk level according to at least any of the total number of the customization processes included in each combinatorial pattern, the number of the different customization processes corresponding to the same requirement information, and a degree of complexity of the customization processes, in a sixth database;
checking said combinatorial patterns against said sixth database to extract said combination-considered point for each combinatorial pattern; and
accumulating said points and said combination-considered point for each said combinatorial pattern to output the accumulated point to the output interface.

8. A method according to claim 6, further comprising the steps of;
accepting selection among the customization processes from said input interface; and
storing the selected customization process in a work table.

9. A method according to claim 8, further comprising the step of increasing said point in accordance with the number of the customization processes stored in said work table.

10. A method according to claim 9, further comprising the step of increasing said point if the number of the customization processes stored in said work table is equal to or more than a predetermined number.

11. An information processing device for supporting utilization of existing contents comprising:
a first database in which physical design purposes and physical design targets of the existing contents are described;
a second database in which a list of customization processes performable on the respective physical design purposes and the respective physical design targets in the first database is described;
an input interface for accepting information on a requirement in which contents scheduled to be designed have different design contents from those of the existing contents;
a unit for checking said requirement information against said first database and retrieve any of the corresponding physical design purpose and the corresponding physical design target;
a unit for checking any of said retrieved physical design purpose and said retrieved physical design target against said second database and extracting the corresponding customization process; and
a unit for outputting information on said extracted customization process to an output interface.

12. An information processing device according to claim 11, further comprising:
a third database in which the design contents of each existing content are described;
a unit for accepting information on the design contents required for the contents scheduled to be designed from said input interface;
a unit for checking said accepted design content information against said third database and extracting the relevant existing content;
a unit for outputting a list of said extracted existing content to the output interface; and
a unit for accepting a difference of design contents from said outputted existing content as said requirement information.

13. An information processing device according to claim 11,
wherein the physical design purposes of the contents in said first database comprise non-functional requirements unrelated to application specifications of the existing contents and said physical design targets comprise functional requirements including any of hardware specifications, software specifications, and the application specifications of the existing contents, and
said information processing device further comprises a unit for accepting any of said non-functional requirements and said functional requirements as the requirement information in the unit for accepting said requirement information.

14. An information processing device according to claim 11, further comprising:
a fourth database storing execution history data of said customization processes;
a unit for checking said extracted customization process against said fourth database and extracting the execution history data on the relevant customization process; and
a unit for outputting said extracted execution history data to the output interface.

15. An information processing device according to claim 11, further comprising:
a unit for recognizing combinatorial patterns of the customization processes if the number of said extracted customization processes for any of one physical design purpose and one physical design target is more than one; and
a unit for outputting said recognized combinatorial patterns to the output interface.

16. An information processing device according to claim 15, further comprising:
a fifth database in which relationships between said customization processes and points of process risk level set for the respective customization processes are defined;
a unit for checking said extracted customization processes against said fifth database and extracting the points according to process risk level of the customization processes; and
a unit for accumulating said points for each said combinatorial pattern and outputting the accumulated points to the output interface.

17. An information processing device according to claim 16, further comprising:
a sixth database in which a combination-considered point of process risk level according to at least any of a total number of the customization processes included in each combinatorial pattern, a number of the different customization processes corresponding to the same requirement information, and a degree of complexity of the customization processes is defined;
a unit for checking said combinatorial patterns against said sixth database and extracting said combination-considered point for each combinatorial pattern; and
a unit for accumulating said points and said combination-considered point for each said combinatorial pattern and outputting the accumulated point to the output interface

18. An information processing device according to claim 18, further comprising;
a unit for accepting a selection among the customization processes from said input interface;
a unit for storing the selected customization process in a work table; and
a unit for increasing said point if the number of the customization processes stored in said work table is equal to or larger than a predetermined number.

19. A computer software program for making an information processing device to support utilization of existing contents, the information processing device being capable of accessing a first database in which physical design purposes and physical design targets of the existing contents are described and a second database in which a list of customization processes performable on the respective physical design purposes and the respective physical design targets in the first database is described, the program causes the information processing device to execute the steps of:
accepting, from an input interface, information on a requirement in which contents scheduled to be designed have different design contents from those of the existing contents;
checking said requirement information against the first database to retrieve any of the corresponding physical design purpose and the corresponding physical design target;
checking any of said retrieved physical design purpose and said retrieved physical design target against said second database to extract the corresponding customization process; and
outputting information on said extracted customization process to an output interface.

20. A computer-readable medium containing the computer software program according to claim 19.
